(19) United States
(12) Patent Application Publication
(10) Pub. No.: US 2019/0019082 A1
(43) Pub. Date: Jan. 17, 2019

(54) COOPERATIVE NEURAL NETWORK REINFORCEMENT LEARNING

(71) Applicant: International Business Machines Corporation, Armonk, NY (US)

(72) Inventors: Sakyasingha Dasgupta, Tokyo (JP); Tetsuro Morimura, Tokyo (JP); Takayuki Osogami, Yamato (JP)

(21) Appl. No.: 15/647,543

(22) Filed: Jul. 12, 2017

(51) Int. Cl. G06N 3/08; G06N 3/04; G06N 3/063

(52) U.S. Cl. CPC G06N 3/08; G06N 3/063; G06N 3/0454

(57) ABSTRACT

Cooperative neural networks reinforcement learning may be performed by obtaining an action and observation sequence, inputting each time frame of the action and observation sequence sequentially into a first neural network including a plurality of first parameters and a second neural network including a plurality of second parameters, approximating an action-value function using the first neural network, and updating the plurality of second parameters to approximate a policy of actions by using updated first parameters.

### TECHNICAL FIELD

The present disclosure relates to reinforcement learning with cooperative neural networks. More specifically, the present disclosure relates to reinforcement learning with cooperative neural networks modelling a Partially Observable Markov Decision Process (POMDP).

### BACKGROUND

One difficulty for reinforcement learning (RL) is to learn near optimal policies in high-dimensional state or action spaces, especially when there is non-Markovian or partially observable state space. There has been recent progress in learning human level control policies on different video games or even learn the high-dimensional state. However, many of these may be suitable for Markovian environments and may have limited memory unless coupled with additional recurrent networks.

Previous work on energy-based RL has been mainly focused on restricted Boltzmann machines (RBMs), where the action-value function is approximated by the negative free-energy of an RBM, and trained using temporal difference (TD)-learning. However, due to the hidden layer of RBMs, this amounts to TD-learning with a non-linear value function. Non-linear TD learning, however, is known to diverge in theory. Furthermore, these methods cannot directly deal with partially observable Markov decision process (POMDP) problems requiring memory of past actions and observations.

### SUMMARY

Some embodiments include a method of obtaining an action and observation sequence, inputting each time frame of the action and observation sequence sequentially into a first neural network including a plurality of first parameters and a second neural network including a plurality of second parameters, approximating an action-value function using the first neural network, and updating the plurality of second parameters to approximate a policy of actions by using updated first parameters.

In some embodiments, the method may shorten the time to converge on a maximized average reward.

Some embodiments include a program for implementing the method, a computer executing the program, and an apparatus that performs the method.

### BRIEF DESCRIPTION OF THE DRAWINGS

FIG. 1 shows an apparatus for cooperative neural network reinforcement learning.

FIG. 2 shows a dynamic Boltzmann machine (DyBM) as an example of a neural network.

FIG. 3 shows a connection between a presynaptic neuron and a post-synaptic neuron via a first in first out (FIFO) queue.

FIG. 4 shows a diagram of cooperative neural networks for reinforcement learning, a.

FIG. 5 shows a flow diagram for cooperative neural network reinforcement learning.

FIG. 6 shows a flow diagram for selecting a possible action.

FIG. 7 shows a flow diagram for approximating an action-value function.

FIG. 8 shows an exemplary hardware configuration of a computer configured for cooperative neural network reinforcement learning.

FIG. 9 depicts a cloud computing environment according to embodiments of the present disclosure.

FIG. 10 depicts abstraction model layers according to embodiments of the present disclosure.

### DETAILED DESCRIPTION

Hereinafter, example embodiments will be described. The example embodiments shall not limit the disclosure according to the claims, and the combinations of the features described in the embodiments are not necessarily essential to the disclosure.

In the original model of a Dynamic Boltzmann Machine (DyBM) there was no provision in the learning rule for learning with rewards or punishments, i.e. reinforcement learning (RL). Based on evaluative feedback in the form of rewards or punishments, reinforcement learning provides a framework for efficient control. A method called Dynamic State-Action-Reward-State-Action (DySARSA) was proposed for temporal difference RL with DyBM utilizing its energy function.

Actor only methods of RL can work by selecting a policy from a list of policies. An estimation is made by simulation to estimate the gradient of the performance. New gradients are estimated independently of previous estimates of other policies. Critic only methods rely on value function approximation to find a near optimal policy. The critic monitors the performance of the actor to determine when the policy can be changed. Actor-critic methods combine actor-only and critic-only methods to allow for the methods to be represented explicitly but to learn separately.

DySARSA does not diverge, and may outperform previous energy-based RL methods. However, DySARSA may be slow in high-dimensional state-action spaces. DySARSA is a value based RL technique that learns with an E-greedy policy. For high-dimensional problems, DySARSA may be suitable to search directly for the optimal policy that achieves maximum future reward. This may be possible using a policy gradient approach called actor-critic reinforcement learning. Such a method may use a DyBM as an actor neural network whose parameters can be updated along with a suitable critic neural network.

Embodiments herein may be referred to as DyNAC (DyBM Natural Actor-Critic) to update the parameters of a DyBM actor neural network using the energy, and following the natural gradient of a cooperative critic neural network parameters. The actor portion of the method updates the policy directly and the critic portion of the method evaluates the value functions. This may enable the DyBM actor neural network to learn and converge quickly to near-optimal policies in high-dimensional action spaces for partially observable Markov decision process (POMDP).

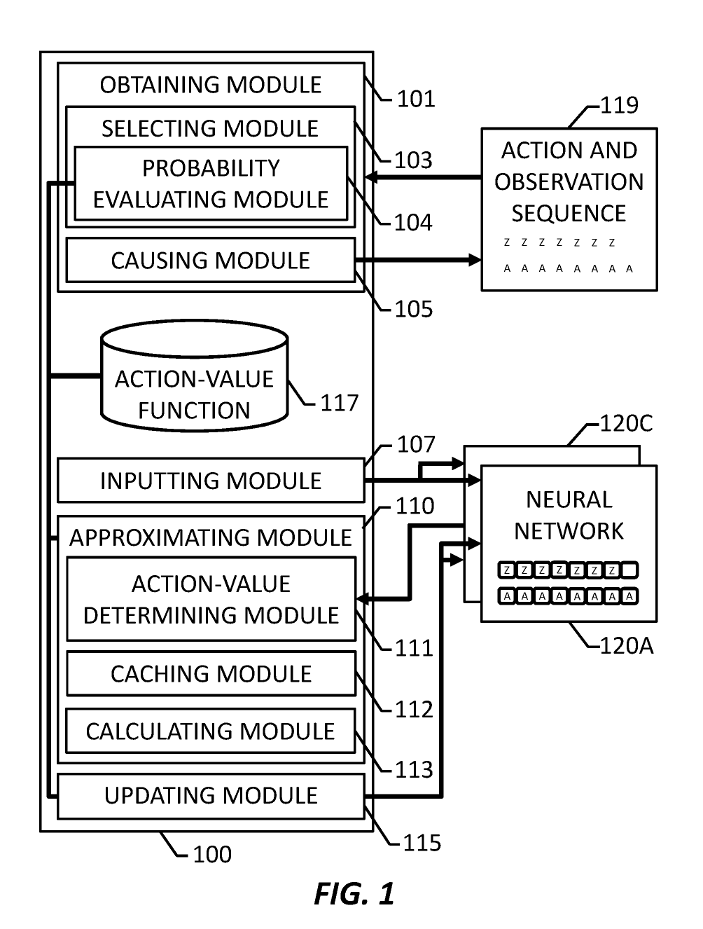

FIG. 1 shows an apparatus 100 for cooperative neural network reinforcement learning, according to some embodiments. Apparatus 100 may be a host computer such as a server computer or a mainframe computer that executes an on-premise application and hosts client computers that use it. Apparatus 100 may be a computer system that includes two or more computers. Alternatively, apparatus 100 may be a personal computer that executes an application for a user of apparatus 100. Apparatus 100 may perform reinforcement learning on cooperative neural networks adapted for an action and observation sequence by using a critic neural network to approximate an action-value function of the action and observation sequence, and updating the parameters of the actor neural network based on the parameters of the critic neural network, which may be updated based on the energy of the critic neural network.

Apparatus 100 may include an obtaining module 101, which may include a selecting module 103 including a probability evaluating module 104, and a causing module 105, an inputting module 107, an approximating module 110, which may include an action-value determining module 111, a caching module 112, and a calculating module 113, and an updating module 114. Apparatus 100 may be a computer program product including one or more computer readable storage mediums collectively storing program instructions that are executable by a computer to cause the computer to perform the operations of the various modules. Apparatus 100 may alternatively be analog or digital programmable circuitry, or any combination thereof. Apparatus 100 may alternatively be a computer on which the computer program product installed. Apparatus 100 may be composed of physically separated storage or circuitry that interacts through communication.

Apparatus 100 may interact with action and observation sequence 119, which may be a person, a machine, or other object subject to modelling as a POMDP. The observations may be observed through sensors, and actions may be caused through instructions or physical interaction. Action and observation sequence 119 may be represented by a computer program, such as a game, which is bound by a digitally created environment. Such a computer program may be observed by receiving data output from the program, and actions may be caused by issuing commands to be executed by the computer program.

Obtaining module 101 may receive data from data storage in communication with apparatus 100. For example, obtaining module 101 may be operable to obtain an action and observation sequence, such as action and observation sequence 119. Action and observation sequence 119 may be obtained sequentially as the actions are performed and the observations are observed. For example, obtaining module 101 may be operable to obtain an observation of a subsequent time frame of action and observation sequence 119. Alternatively, obtaining module 101 may be operable to obtain an entire action and observation sequence for a set of time frames, such as a training sequence, complete with actions and observations at each time frame. Obtaining module 101 may communicate directly with such data stores, or may utilize a transceiver to communicate with a computer through wired or wireless communication across a network.

Selecting module 103 may select an action. For example, selecting module 103 may be operable to select an action, using actor neural network 120A, with which to proceed from a current time frame of the action and observation sequence to a subsequent time frame of action and observation sequence 119.

Probability evaluation module 104 may evaluate a reward probability of a possible action. For example, probability evaluating module 104 may be operable to evaluate each reward probability of a plurality of possible actions according to a probability function based on an action-value function, such as action-value function 117. In many embodiments, selecting module 104 may select the possible action that yields the largest reward probability from the probability function.

Causing module 105 may cause an action to be performed. For example, causing module 105 may be operable to cause the action selected by selecting module 103 to be performed in the subsequent time frame of action and observation sequence 119.

Inputting module 107 may input values into input nodes of cooperative neural networks. For example, inputting module 107 may be operable to input each time frame of action and observation sequence 119 sequentially into a first neural network including a plurality of first parameters and a second neural network including a plurality of second parameters, such as actor neural network 120A and critic neural network 120C, respectively.

Approximating module 110 may approximate an action-value function of a neural network. For example, approximating module 110 may approximate action-value function 117 using critic neural network 120C.

Action-value determining module 111 may determine an action-value. For example, action-value determining module 111 may be operable to determine a current action-value from an evaluation of action-value function 117 in consideration of an actual reward.

Caching module 112 may cache values and parameters for functions and neural networks. For example, caching module 112 may be operable to cache a previous action-value determined for a previous time frame from action-value function 117. Caching module 108 may also be operable to cache parameters of cooperative neural networks 120A and 120C, such as eligibility traces, weights, biases, and function parameters for determining such parameters of cooperative neural networks 120A and 120C.

Calculating module 113 may calculate parameters. For example, calculating module 113 may be operable to calculate a temporal difference error based on an average estimate of reward over time, the previous action-value, the current action-value, and the plurality of parameters of critic neural network 120C.

Updating module 115 may update the parameters of cooperative neural networks, such as actor neural network 120A and critic neural network 120C. For example, updating module 115 may update a plurality of parameters of actor neural network 120A by using parameters of critic neural network 120C to approximate a policy of actions. Updating module 115 may update the parameters of critic neural network 120C based on the action-value function.

An apparatus, such as apparatus 100, may be beneficial when at least the actor neural network is a DyBM. Apparatus 100 can also be beneficial when the critic neural network is a neural network that is a linear function approximator and has the same dimensionality of parameters as the actor neural network, of which a DyBM also qualifies, because in that manner the actor neural network and the critic neural network have the same structure.

A DyBM may be defined from a BM having multiple layers of units, where one layer represents the most recent values of a time-series, and the remaining layers represent the historical values of the time-series. The most recent values are conditionally independent of each other given the historical values. It may be equivalent to such a BM having an infinite number of layers, so that the most recent values can depend on the whole history of the time series. For unsupervised learning, a DyBM may be trained in such a way that the likelihood of a given time-series is maximized with respect to the conditional distribution of the next values given the historical values. Similar to a BM, a DyBM may consist of a network of artificial neurons. In some embodiments using a DyBM, each neuron may take a binary value, 0 or 1, following a probability distribution that depends on the parameters of the DyBM. In other embodiments using a DyBM, each neuron may take a real value, an integer value, or a multi-value. Unlike the BM, the values of the DyBM can change over time in a way that depends on its previous values. That is, the DyBM may stochastically generate a multi-dimensional series of binary values.

Learning in conventional BMs may be based on a Hebbian formulation, but is often approximated with a sampling based strategy like contrastive divergence. In this formulation, the concept of time is largely missing. In DyBM, like biological networks, learning may be dependent on the timing of spikes. This is called spike-timing dependent plasticity, or STDP, which means that a synapse is strengthened if the spike of a pre-synaptic neuron precedes the spike of a post-synaptic neuron (long term potentiation—LTP), and the synapse is weakened if the temporal order is reversed (long term depression—LTD). The conventional DyBM may use an exact online learning rule that has the properties of LTP and LTD.

In embodiments of an apparatus in which entire action and observation sequences are obtained at once, such as training sequences, the apparatus may not require a selecting module or a causing module, because the actions are already determined as part of the sequence.

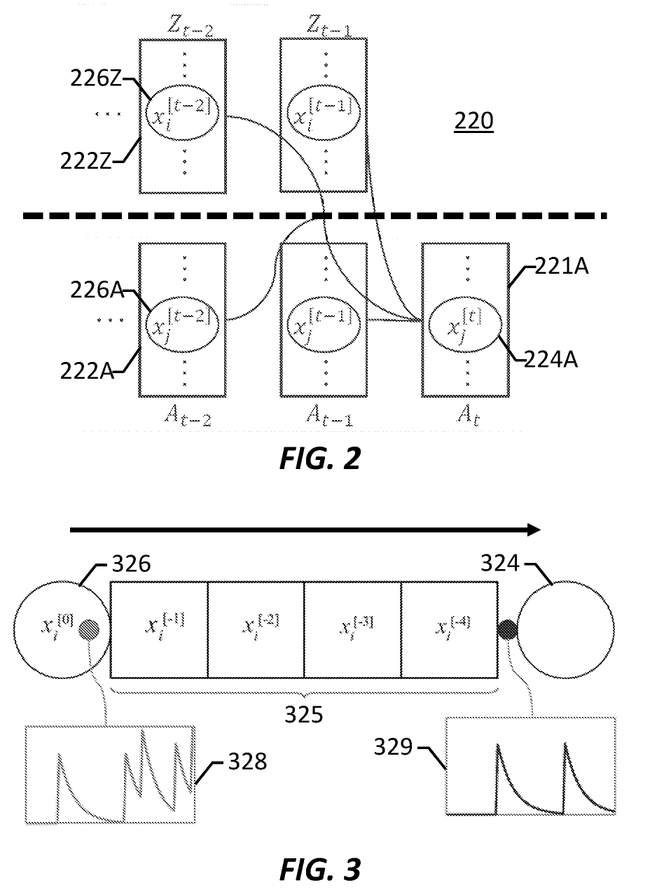

FIG. 2 shows a DyBM as an example of a neural network structure, according to some embodiments. DyBM 220 may include a plurality of layers of nodes (e.g. layers 221A, 222A₁, 222A₂, 222Z₁, and 222Z₂) among a plurality of nodes (e.g. 224A, 226A₁, 226A₂, 226Z₁, and 226Z₂). Each layer sequentially forwards input values of a time frame of the action and observation sequence to a subsequent layer among the plurality of layers. The plurality of layers of nodes includes a first layer 221A of input nodes, such as input node 224A, and a plurality of intermediate layers, such as intermediate layer 222A/222Z. In the first layer 221A, the input nodes 224A receive input values representing an action of a current time frame of the action and observation sequence. The plurality of layers of nodes may also include another first layer of other input nodes that receive input values representing an observation of a current time frame of the action and observation sequence.

Each node, such as action node 226A and observation node 226Z, in each intermediate layer forwards a value representing an action or an observation to a node in a subsequent or shared layer. FIG. 2 shows three time frames, t, t−1, and t−2. Each time frame is associated with an action, A, and an observation, Z. The action at time t is represented as Aₜ. The action at time t−1 is represented as Aₜ₋₁, and the action at time t−2 is represented as Aₜ₋₂. The observation at time t−1 is represented as Zₜ₋₁, and the action at time t−2 is represented as Zₜ₋₂. FIG. 3 does not show an observation at time t, because DyBM 220 is shown at a moment in which action Aₜ is being determined, but has not been caused. Thus, in this moment, each other node is presynaptic to the nodes of action Aₜ 221A. Once an action has been selected and caused, DyBM 220 will create input nodes for the observation at time t, Zₜ, for storing binary numbers representing Zₜ. In other implementations, observation Zₜ at time t can be input to Zₜ₋₁ after the current values of Zₜ₋₁, Zₜ₋₂, . . . are forwarded to Zₜ₋₂, Zₜ₋₃, . . . and the current values of Aₜ₋₁, Aₜ₋₂, . . . are forwarded to Aₜ₋₂, Aₜ₋₃, . . . .

In FIG. 2, values representing an action A at time t, t−1, t−2, . . . are denoted xⱼ^{[t]}, xⱼ^{[t-1]}, and xⱼ^{[t-2]}, where j (1≤j≤Nₐ) represents a node number relating to an action and Nₐ represents a number of values (or nodes) in an action. Values representing an observation Z at time t, t−1, and t−2, . . . are denoted xᵢ^{[t]}, xᵢ^{[t-1]}, xᵢ^{[t-2]}, where i (1≤i≤N_{b}) represents a node number relating to an observation and N_{b} represents a number of values (or nodes) in an observation.

Each action, A, and each observation, Z, at each time frame of DyBM 220 may be represented as a plurality of binary numbers. For example, if there are 256 possible actions, then each action can be represented as a permutation of 8 binary numerals. Input node 224A is a binary numeral representing the action at time t, and is represented as xⱼ^{[t]}. Action node 226A is a binary numeral representing the action at time t−2, and is represented as xⱼ^{[t-2]}. The action node representing the action at time t−1 is represented as xⱼ^{[t-1]}. Observation node 226Z is a binary numeral representing the observation at time t−2, and is represented as xᵢ^{[t-2]}. The observation node representing the observation at time t−1 is represented as xᵢ^{[t-1]}.

DyBM 220 may also include a plurality of weight values among the plurality of parameters of the neural network. Each weight value is to be applied to each value in the corresponding node to obtain a value propagating from a pre-synaptic node to a post-synaptic node.

FIG. 3 shows a connection between a presynaptic neuron 326, which has a neural eligibility trace 328, and a post-synaptic neuron 324 via a FIFO queue 325, which has a synaptic eligibility trace 329, according to some embodiments. Although the diagram of DyBM 320 shown in FIG. 3 looks different from the diagram of DyBM 220 shown in FIG. 2, these diagrams represent a same or similar structure of DyBM. In FIG. 3, values from nodes xⱼ^{[t-1]}, xⱼ^{[t-2]}, . . . of the same j in FIG. 2 are sequentially stored in a FIFO queue 325 (shown as xⱼ^{[t-1]}, xⱼ^{[t-2]}, . . . ) as an implementation of, for example node 226A forwarding a value from the action and observation sequence. In FIG. 3, values from nodes xᵢ^{[t-1]}, xᵢ^{[t-2]}, . . . of the same i in FIG. 2 are also sequentially stored in a FIFO queue 325 assigned to another i in FIG. 3 corresponding to an i in FIG. 3.

In FIG. 3, DyBM 320 may consist of a set of neurons having memory units and FIFO queues. Let N be the number of neurons. Each neuron may take a binary value at each moment. For j∈[1, N], let xⱼ^{[t]} be the value of the j-th neuron at time t.

A neuron, i∈[1, N], may be connected to another neuron, j∈[1, N], with a FIFO queue of length d_{i,j}−1, where d_{i,j} is the axonal or synaptic delay of conductance, or conduction delay, from the pre-synaptic neuron, i, to the post-synaptic neuron, j. Please note that the usage of i and j in FIG. 3 is different from that of FIG. 2, since the above usage is more convenient to explain the diagram of FIG. 3. We assume d_{i,j}≥1. At each moment t, the tail of the FIFO queue holds xᵢ^{[t-1]} the head of the FIFO queue holds xᵢ^{[t-d}^{_{i,j}}^{+1]}. A single increment in time causes the value at the head of the FIFO queue to be removed, and the remaining values in the FIFO queues are pushed toward the head by one position. A new value is then inserted at the tail of the FIFO queue. Self-connections via a FIFO queue are permitted.

Each neuron stores a fixed number, L, of neural eligibility traces. For l∈[1, L] and j∈[1, N], let γ_{j,l}^{[t-1]} be the l-th neural eligibility trace of the j-th neuron immediately before time t:

γ_{j,l}^{[t-1]}≡Σ_{s=-∞}^{t-1}μₗ^{t-s}xⱼ^{[s]}, Equation (1)

where μₗ∈(0, 1) is the decay rate for the t-th neural eligibility trace, i.e. the neural eligibility trace is the weighted sum of the past values of that neuron, where the recent values have greater weight than the others.

Each neuron may also store synaptic eligibility traces, where the number of the synaptic eligibility traces depends on the number of the neurons that are connected to that neuron. Namely, for each of the (pre-synaptic) neurons that are connected to a (post-synaptic) neuron j, the neuron j stores a fixed number, K, of synaptic eligibility traces. For k∈[1, K], let α_{i,j,k}^{[t-1]} be the k-th synaptic eligibility trace of the neuron j for the pre-synaptic neuron i immediately before time t:

α_{i,j,k}^{[t-1]}≡Σ_{s=-∞}^{t-d}^{_{i,j}}λₖ^{t-s-d}^{_{i,j}}xᵢ^{[s]}, Equation (2)

where λₖ∈(0, 1) is the decay rate for the k-th synaptic eligibility traces, i.e. the synaptic eligibility trace is the weighted sum of the values that has reached that neuron, j, from a pre-synaptic neuron, i, after the conduction delay, d_{i,j}.

The values of the eligibility traces stored at a neuron, j, are updated locally at time t based on the value of that neuron, j, at time t and the values that have reached that neuron, j, at time t from its pre-synaptic neurons. Specifically,

γ_{j,l}^{[t]}←μₗ(γ_{j,l}^{[t-1]}+xⱼ^{[t]}), Equation (3)

α_{i,j,k}^{[t]}←λₖ(α_{i,j,k}^{[t-1]}+xᵢ^{t-d}^{_{i,j}}), Equation (4)

for l∈[1, L] and k∈[1, K], and for neurons i that are connected to j.

The learnable parameters of DyBM 320 are bias and weight. Specifically, each neuron, j, is associated with bias, bⱼ. Each synapse, or each pair of neurons that are connected via a FIFO queue, is associated with the weight of long term potentiation (LTP weight) and the weight of long term depression (LTD weight). The LTP weight from a (pre-synaptic) neuron, i, to a (post-synaptic) neuron, j, is characterized with K parameters, u_{i,j,k} for k∈[1, K]. The k-th LTP weight corresponds to the k-th synaptic eligibility trace for k∈[1, K]. The LTD weight from a (pre-synaptic) neuron, i, to a (post-synaptic) neuron, j, is characterized with L parameters, v_{i,j,k} for l∈[1, L]. The l-th LTD weight corresponds to the l-th neural eligibility trace for l∈[1, L]. The learnable parameters of such a DyBM actor neural network are collectively denoted with θ.

Similar to the conventional BM (see supplementary), the energy of DyBM 220 determines what patterns of the values that DyBM 220 is more likely to generate than others. Contrary to the conventional BM, the energy associated with a pattern at a moment depends on the patterns that DyBM 220 has previously generated. Let x^{[t]}=(x^{j[t]})_{j∈[1,N]} be the vector of the values of the neurons at time t. Let x^{[:t-1]}=(x^{[s]})_{s<t} be the sequence of the values of DyBM 220 before time t. The energy of DyBM 220 at time t depends not only on x^{[t]} but also on x^{[:t-1]}, which is stored as eligibility traces in DyBM 220. Let E_{θ}(x^{[t]}|x^{[:t-1]}) be the energy of DyBM 220 at time t. The lower the energy of DyBM 220 with particular values x^{[t]}, the more likely DyBM 220 takes those values. The energy of DyBM 220 can be decomposed into the energy of each neuron at time t:

E_{θ}(x^{[t]}|x^{[:t-1]})=Σⱼ₌₁^{H}E_{θ}(x^{[t]}|x^{[:t-1]}), Equation (5)

The energy of the neuron j at time t depends on the value it takes as follows (see supplementary for explanation of the individual components):

E_{θ}(x^{[t]}|x^{[:t-1]})=−bⱼxⱼ^{[t]}−Σ_{i∈A∪Z}Σₖ₌₁^{K}u_{i,j,k}α_{i,j,k}^{[t-1]}xⱼ^{[t]}+Σ_{i∈A∪Z}Σₗ₌₁^{L}v_{i,j,l}β_{i,j,l}^{[t-1]}xⱼ^{[t]}+Σ_{i∈A∪Z}Σₗ₌₁^{L}v_{j,i,l}γ_{i,l}^{[t-1]}xⱼ^{[t]}, Equation (6)

Where u_{i,j,k} and v_{i,j,l} are weights, and

β_{i,j,l}^{[t-1]}xⱼ^{[t]}≡Σ_{s=t-d}_{_{i,j+1}}^{t-1}μₗ^{s-t}xᵢ^{[s]}. Equation (7)

To perform reinforcement learning with SARSA for a POMDP using DyBM 220, the set of nodes (neurons) in the network are divided into two groups. One group represents actions and is denoted by A. The other represents observations and is denoted by Z. That is, an action that we take at time t is denoted by a vector x_{A}^{[t]}≡(xⱼ^{[t]})_{j∈A}, and the observation that we make immediately after we take that action is analogously denoted by x_{Z}^{[t]}. The pair of the action and the observation at time t is denoted by x≡(xⱼ^{[t]})_{j∈A∪Z}. Here, an observation can include the information about the reward that we receive, if the past reward affects what actions will be optimal in the future. The actions that we take are certainly observable, but we separate the action from observation for convenience.

In some embodiments, it is also possible to predict values of an observation Zₜ once an action Aₜ has been fixed in the neural network. In this case, values xᵢ^{[t]} in Zₜ can also be predicted, and Zₜ works as an input layer including input nodes xᵢ^{[t]}. In further embodiments, all of the values xᵢ^{[t]} and xⱼ^{[t]} of both Zₜ and Aₜ may be predicted.

DyBM exhibits some of the key properties of STDP due to its structure consisting of conduction delays, such as pre-synaptic neuron 326, and memory units, such as FIFO queue 325. A neuron may be connected to another in a way that a spike from pre-synaptic neuron 326, i, travels along an axon and reaches post-synaptic neuron 324, j, via a synapse after a delay consisting of a constant period, d_{i,j}. FIFO queue 325 causes this conduction delay. FIFO queue 325 may store the values of pre-synaptic neuron 326 for the last d_{i,j}−1 units of time. Each stored value may be pushed one position toward the head of the queue when the time is incremented by one unit. The value of pre-synaptic neuron 326 is thus given to post-synaptic neuron 324 after the conduction delay. Moreover, the DyBM aggregates information about the spikes in the past into neural eligibility trace 328 and synaptic eligibility trace 329, which are stored in the memory units. Each neuron is associated with a learnable parameter called bias. The strength of the synapse between pre-synaptic neuron 326 and post-synaptic neuron 324 is represented by learnable parameters called weights, which may be further divided into LTP and LTD components.

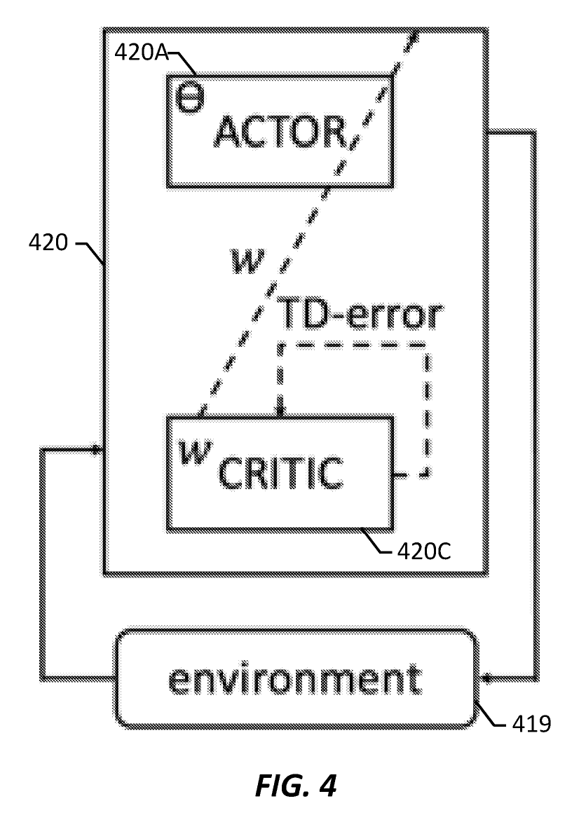

FIG. 4 shows a diagram of cooperative neural networks, such as a DyNAC, for reinforcement learning, according to some embodiments. Cooperative neural networks for reinforcement learning may include an environment 419 and a cooperative neural network system 420, which may include an actor neural network 420A having parameters θ and a critic neural network 420C having parameters w. The environment may be where the actions are performed and the observations are made. The parameters w of critic neural network 420C may be used to update the parameters θ of actor neural network 420A. Calculation of a TD error of critic neural network 420C may be used to approximate an action-value function of critic neural network 420C.

The cooperative neural networks in FIG. 4 may be based on a policy gradient method that may try to learn an optimal policy that locally maximizes the average reward (rₜ) over time.

$$J ( θ ) = {lim}_{T \to ∞} \frac{1}{T} {E}^{θ} [ {\sum }_{t = 1}^{T} {r}_{t} ] , \qquad Equation ( 8 )$$

where J(θ) is the policy based on the actor parameters θ.

FIG. 4 depicts cooperative neural network system 420 for performing a method of selecting actions in reinforcement learning where actor neural network 420A may select actions and critic neural network 420C may evaluate the values of those actions in view of prior actions and observations. Actor neural network 420A may choose the actions based on the energy of a Dynamic Boltzmann machine (DyBM), and the parameters of actor neural network 420A may be updated using the parameters of critic neural network 420C. In many embodiments, each cooperative neural network 420A can be divided into two parts. One group of nodes may represent actions, and is denoted by A. The other may represent observations, and is denoted by Z. The weight and bias parameters of actor neural network 420A may be collectively denoted by θ. The observation may include information about an actual reward received in response to an action if the actual reward affects what actions will be optimal in the future. Actor neural network 420A is connected to a suitable critic neural network 420C, whose parameters are denoted by w.

The actor neural network parameters θ are updated following the natural gradient in the direction of w:

u^{θ}=u^{θ}+βu^{w}, Equation (9)

Where u^{θ} and u^{w} are the vectors of parameters of actor neural network 420A and critic neural network 420C, respectively. Based on this, an action may be selected using a Boltzmann exploration policy and energy of the actor neural network E_{θ}:

$$Pr ( {x}_{j}^{[ t ]} = 1 ) = \frac{1}{1 + exp ( {τ}^{- 1} {E}_{θ} ( {x}_{j}^{[ t ]} = 1 \vert {x}^{[ : t - 1 ]} ) )} , \qquad Equation ( 10 )$$

Any suitable function approximator may be used as the critic neural network in a DyNAC, and if a DyBM is also used as a critic neural network, then the energy of the critic DyBM can be used to approximate the action-value function.

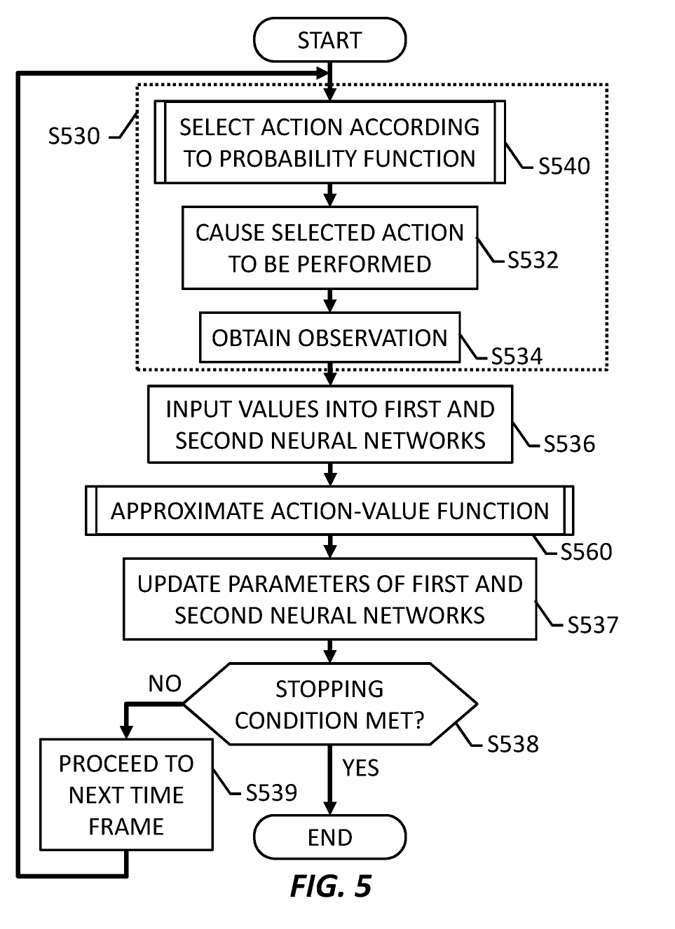

FIG. 5 shows an operational flow for cooperative neural network reinforcement learning, according to some embodiments. The operational flow may provide a method of perform reinforcement learning on a cooperative neural network system adapted for an action and observation sequence, such as a DyNAC. The operations may be performed by an apparatus, such as apparatus 100.

At S530, an obtaining module, such as obtaining module 101, may obtain an action and observation sequence. More specifically, as the operational flow of FIG. 5 is iteratively performed, the iterations of the operations of S530 collectively amount to an operation of obtaining the action and observation sequence. Operation S530 may include operations S540, S532, and S534. Alternatively at S530, the obtaining module may obtain an entire action and observation sequence for a set of time frames, such as a training sequence, complete with actions and observations at each time frame.

At S540, a selecting module, such as selecting module 103, may select an action according to a probability function. For example, the selecting module may select an action, using the actor neural network, with which to proceed from a current time frame of the action and observation sequence to a subsequent time frame of the action and observation sequence.

At S532, a causing module, such as causing module 105, may cause the selected action to be performed. For example, the causing module may cause the action selected at S540 to be performed in the subsequent time frame of the action and observation sequence. Depending on the nature of the action and observation sequence, actions may be caused through instructions or physical interaction, such as in the case of a human or machine, in which case the actions may be performed by the human or the machine, or caused by issuing commands to be executed by the computer program, in which case the actions are performed by the computer program.

At S534, the obtaining module may obtain an observation. For example, the obtaining module may obtain an observation of the subsequent time frame of the action and observation sequence. Once the selected action has been performed, certain observations can be sensed, detected, measured, or otherwise received by the obtaining module. The setting of reinforcement learning may be where a (Markovian) state cannot be observed (i.e., our setting is modeled as a partially observable Markov decision process or POMDP). If such a state was observable, a policy that maps a state to an action could be sought, because the future would become conditionally independent of the past given the state. In a partially observable state setting, the optimal policy may depend on the entire history of prior observations and actions, which are represented as xᵢ^{[t-n]} in FIG. 2. In some embodiments, the observation obtained may also include or be accompanied by an actual reward, which may reduce the number of time frames required for convergence, but may also require more computational resources. The actual reward may be supplied through conscious feedback, such as in indication by a person, or calculated from, for example, a final state, and is therefore assumed to be factual.

At S536, an input module, such as input module 107, may input values corresponding to the current time frame into each neural network of a cooperative neural network system. As the operational flow of FIG. 5 is iteratively performed, the iterations of the operations of S536 collectively amount to the input module inputting each time frame of the action and observation sequence sequentially into a plurality of input nodes of each neural network of the cooperative neural network system.

At S560, an approximating module, such as approximating module 110, may approximate an action-value function of a critic neural network, such as critic neural network 120C. For example, the approximating module may approximate an action-value function based on the principles of SARSA or, when the critic neural network is a DyBM, the principles of DySARSA.

At S537, an updating module, such as updating module 115, may update parameters of each neural network of the cooperative neural network system. For example, the updating module may update a plurality of parameters of the critic neural network based on the action-value function approximated by the approximating module, and may update a plurality of parameters of the actor neural network based on the plurality of updated parameters of the critic neural network. By updating the parameters of the actor neural network, the approximation of a policy function may become more accurate, which may in turn improve the accuracy of the probability function, which may result in the selection of actions that more effectively achieve goals. The updating module may update the eligibility traces and any FIFO queues of either neural network. In other words, the updating the plurality of parameters of the neural network includes updating a plurality of eligibility traces and a plurality of first-in-first-out (FIFO) queues. The eligibility traces and FIFO queues may be updated with Equations 3, 4, and 7.

At S538, the apparatus may determine whether a stopping condition is met. If the stopping condition is met, such as if a maximum number of iterations have been performed, then the operational flow is discontinued. If the stopping condition is not met, such as if a maximum number of iterations have not yet been performed, then the operational flow proceeds to S539.

At S539, the apparatus proceeds to the next time frame, and the operational flow returns to operation S530 to perform the next iteration. In the next iteration, the current time frame becomes a previous time frame, and the subsequent time frame becomes the current time frame.

In other embodiments of an operational flow for cooperative neural network reinforcement learning, the updating module may update the parameters of each neural network every other iteration, every third iteration, and so on. The number of iterations before performing an update may change, and/or may depend on the rewards.

In embodiments of operational flow for cooperative neural network reinforcement learning in which entire action and observation sequences are obtained at once, such as training sequences, the operational flow may not require a selecting operation or a causing operation, because the actions are already determined as part of the sequence. In further embodiments, such training sequences may be run through the operational flow multiple times and combined with different training sequences to train the cooperative neural network system.

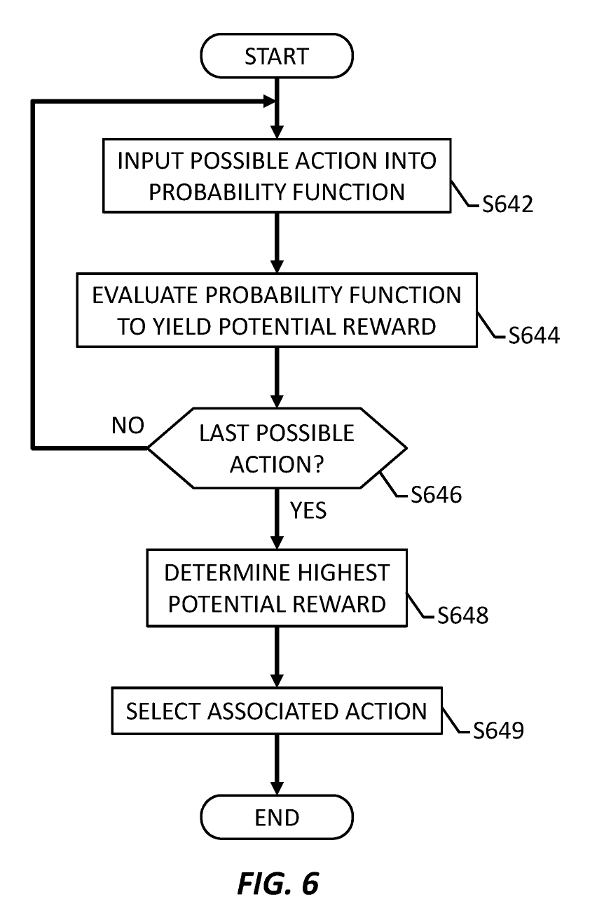

FIG. 6 shows an operational flow for selecting a possible action, according to some embodiments. The operational flow may provide a method of selecting an action according to a probability function. The operations may be performed by an apparatus, such as apparatus 100, using an actor neural network, such as actor neural network 120A.

At S642, a selecting module, such as selecting module 103, may input a possible action into a probability function. For example, out of all possible actions, a single possible action may be input into the probability function. Once the possible action is input into the probability function, the selecting module may make an indication, such as by updating a pointer, so that the same possible action is not input into the probability function twice in a single time frame. In embodiments where the actor neural network is as shown in FIG. 3, each permutation of binary action input nodes xⱼ^{[t]} may represent a possible action.

At S644, a probability evaluating module, such as probability evaluating module 103, may evaluate the probability function to yield a reward probability, or the probability that a possible action will result in receiving a reward. As operations S642 and S644 are iteratively performed, the selecting module evaluates each reward probability of a plurality of possible actions according to the probability function based on the action-value function.

At S646, the selecting module may determine whether any unevaluated possible actions remain. If the last possible action has not yet been evaluated, then the operational flow returns to S642. If the last possible action has been evaluated, then the operational flow proceeds to S648.

At S648, the selecting module may determine the highest reward probability that was yielded from the evaluations performed by the probability evaluating module at S544.

At S649, the selecting module may select the possible action that is associated with the highest reward probability determined at S648. In other words, the selected action among the plurality of possible actions yields the largest reward probability from the probability function. Once the possible action has been selected, the operational flow proceeds to cause the selected action, such as S532 in FIG. 5, to be performed.

In alternative embodiments of an operational flow for selecting a possible action, each node of the action may be evaluated individually. Because the value of each node is not affected by the values of other nodes, an operation can determine each action node individually. When all nodes have been determined individually, the action represented by result of each node is the selected action.

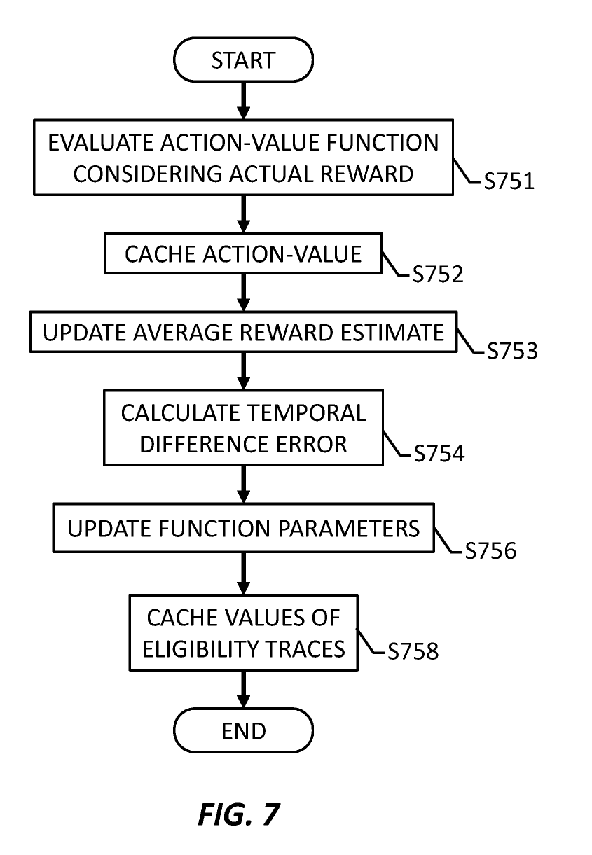

FIG. 7 shows an operational flow for approximating an action-value function of a critic neural network, according to some embodiments. The operational flow may provide a method for approximating an action-value function of a critic neural network of a cooperative neural network system, such as a DyNAC. The operations may be performed by an apparatus, such as apparatus 100, using a critic neural network, such as critic neural network 120C. Before showing the operational flow shown in FIG. 7, underlying theory is explained below.

An approach for reinforcement learning in general, which may be applied to a critic neural network in a cooperative neural network system, is called SARSA, which refers to a general class of on-policy TD-learning methods for RL. SARSA stands for State-Action-Reward-State-Action, as a representation of its formula. SARSA updates an action-value function Q according to

Q(Sₜ,Aₜ)←Q(Sₜ,Aₜ)+η(Rₜ₊₁+γQ(Sₜ₊₁,Aₜ₊₁)−Q(Sₜ,Aₜ)), Equation(11)

where Sₜ is the (Markovian and observable) state at time t, Aₜ is the action that we take at time t, Rₜ₊₁ is the reward that we receive after taking Aₜ, γ is the discount factor for future reward, and η is the learning rate. In our case, the Markovian state is not observable, and Sₜ refers to the entire history of observations and actions before t (i.e., Sₜ=x^{[:t-1]}).

In some embodiments, the action-value function may be an energy function of the critic neural network. By Equation (5), the energy of a DyBM having the structure in FIG. 2 can be decomposed into a sum of the energy associated with its individual nodes as follows:

E_{θ}(x^{[t]}|x^{[:t-1]})=Σ_{j∈A∪Z}E_{θ}(xⱼ^{[t]}|x^{[:t-1]}), Equation (12)

In this embodiment of cooperative neural network reinforcement learning, we use the energy associated with the observations to represent the function-Q:

Q_{θ}(x^{[:t-1]},x_{A}^{[t]})≈\hat{Q}_{w}(x^{[:t-1]},x_{A}^{[t]})=−Σ_{j∈A}E_{θ}(xⱼ^{[t]}|x^{[:t-1]}), Equation (13)

where E_{θ}(xⱼ^{[t]}|x^{[:t-1]}) is given by Equation (6). Recall that α_{i,j,k}^{[t-1]}, β_{i,j,l}^{[t-1]}, and γ_{i,l}^{[t-1]} in Equation (6) are updated at each time step using Equations (3), (4) and (7).

In other embodiments, the action-value function may be a linear function. In many embodiments, such as embodiments where the critic neural network is a DyBM, the action-value function is a linear energy function of the critic neural network. The approximate Q-function Equation (13) is linear with respect to the parameters of the critic DyBM. This is in contrast to ESARSA, where the free-energy of a Restricted Boltzmann Machine (RBM) is used to approximate the Q-function. Due to the hidden nodes in an RBM, this is a non-linear function approximation method, which may diverge in theory and practice. However, convergence of SARSA with a linear function approximation may be guaranteed under suitable conditions.

When the Q-function is approximated with a linear function of parameters, θ, such that:

Q_{θ}(S,A)=ϕ(S,A)^{T}θ, Equation (14)

a SARSA learning rule may be given by

θₜ₊₁=θₜ+ηₜΔₜϕ(Sₜ,Aₜ), Equation (15)

where ηₜ is a learning rate, and Δₜ is a TD error:

Δₜ=Rₜ₊₁+γϕ(Sₜ₊₁,Aₜ₊₁)^{T}θₜ−ϕ(Sₜ,Aₜ)^{T}θₜ, Equation (16)

In this embodiment, the exact DySARSA learning rule is ∀j∈A, ∀i∈A∪S, k=1, . . . , K, l=1, . . . , L

bⱼ←bⱼ+ηₜΔₜxⱼ^{[t]} Equation (17)

u_{i,j,k}←u_{i,j,k}+ηₜΔₜα_{i,j,k}^{[t-1]}xⱼ^{[t]} Equation (18)

v_{i,j,l}←v_{i,j,l}+ηₜΔₜβ_{i,j,l}^{[t-1]}xⱼ^{[t]} Equation (19)

v_{i,j,l}←v_{i,j,l}+ηₜΔₜγ_{i,l}^{[t-1]}xⱼ^{[t]}, Equation (20)

where the TD error is given by

Δₜ=Rₜ+γQ_{θ}_{ₜ}(x^{[:t]},x_{A}^{[t+1]})−Q_{θ}_{_{t−1}}(x^{[:t-1]},x_{A}^{[t]}). Equation (21)

Each v_{i,j,l} is duplicated in Equation (19) and Equation (20) and thus updated twice in each step. This is just for notational convenience, and the two could be merged.

SARSA may allow selection of a subsequent action on the basis of the values of Q for candidate actions. Therefore, actions are selected based on the policy with Boltzmann exploration. Boltzmann exploration is particularly suitable for DyBM, because Equation (13) allows us to sample each bit of an action (i.e., xⱼ^{[t]} for j∈A) independently of each other according to Equation (10) where τ>0 is the parameter representing temperature, and τ→0 leads to a greedy policy. Operation S544 may use Equation (19) as the probability function. Notice that the energy is 0 when xⱼ^{[t]}=0. In this case, DySARSA converges as long as it is greedy in the limit of infinite exploration. Furthermore, recall that the neural and synaptic eligibility traces along with the FIFO queues store the spike timing history in DyBM. As such, the DySARSA learning rule of (Equations (17)-(20)) can be viewed as analogous to a possible biological counterpart in the form of reward or TD-error modulated reinforcement learning.

Overall, the DySARSA learning algorithm may proceeds as described above, where vector notations: α^{[t]}≡(α_{i,j,k}^{[t]})_{i,j-A∪Z,k∈[1,K]}; β^{[t]} and γ^{[t]} may be defined analogously.

However, unlike DySARSA, embodiments of cooperative neural network reinforced learning, such as DyNAC, may use two neural networks: an actor neural network and a critic neural network. Embodiments of DyNAC include methods to update the parameters of an actor DyBM using a policy gradient approach which may utilize the natural gradient of critic network parameters, such as in Equation (9), while DySARSA is a purely value based method. As a result, the objective function may be different between DySARSA and DyNAC. In DySARSA, the objective function may be the expected discounted cumulative reward, while in embodiments of DyNAC the objective function may be to maximize the average reward over time.

Embodiments of DyNAC may use any suitable critic neural network as an action-value function approximator, and a DySARSA DyBM happens to be one such suitable critic neural network. In embodiments of DyNAC, both the actor neural network and the critic neural network can utilize the same network structure of a partitioned space between observation nodes and actor nodes. Embodiments of DyNAC may keep a running estimate of the average reward, which may be used to update the TD-error. As a result, the form of the TD-error may actually be,

Δₜ=Rₜ₊₁+Ĵₜ₊₁+E_{θ}(x_{A}^{[t+1]}|x^{[:t]})−E_{θ}(x_{A}^{[t]}|x^{[:t-1]}), Equation (22)

where the average reward is calculated by

Ĵₜ₊₁=(1−ξ)Ĵₜ+ξrₜ₊₁, Equation (23)

which is different from Equations (16) and (21). Therefore, as TD-error directly effects the parameter updates, a DyBM critic may update its parameters differently than in the DySARSA method. In embodiments of DyNAC, three different learning rates are maintained: ξ is a learning rate of average reward estimate, β (from Equation 9) is a learning rate for actor network parameters, and η is a learning rate for critic network parameters.

In some embodiments where the critic neural network is a DyBM as shown in FIG. 2, the action-value function may be evaluated with respect to nodes of the critic neural network associated with actions of the action and observation sequence. In other embodiments where the critic neural network is a DyBM as shown in FIG. 2, the action-value function may be evaluated with respect to nodes of the critic neural network associated with actions and observations of the action and observation sequence.

The operational flow of FIG. 7 may begin after an inputting module, such as inputting module 105, inputs values into each neural network.

At S751, an action-value determining module, such as action-value determining module 111, may evaluate an action-value function in consideration of an actual reward to determine an action-value. In other words, the approximating the action-value function may further include determining a current action-value from an evaluation of the action-value function in consideration of an actual reward. In some embodiments, the previously cached action-value, such as from a time frame t−2, may be deleted.

At S752, a caching module, such as caching module 112, may cache the action-value determined at a previous iteration of S751. In other words, the approximating the action-value function may further include caching a previous action-value determined from a previous time frame from the action-value function.

At S753, an updating module, such as updating module 115, may update an average reward estimate. The average reward estimate may be calculated using Equation 23.

At S754, a calculating module, such as calculating module 115, may calculate a temporal difference (TD) error, which may be based on the action-value determined at S751 and the plurality of parameters of the critic neural network. In other words, the approximating the action-value function may further include calculating a temporal difference error based on an average estimate of a reward over time, the previous action-value, the current action-value, and the plurality of parameters. The TD-error may be calculated using Equation 22.

At S756, the updating module may update a plurality of function parameters of the critic neural network based on the temporal difference error calculated at S754 and at least one learning rate. In other words, the approximating the action-value function may include updating a plurality of parameters of the critic neural network based on the temporal difference error and a learning rate. These function parameters may be updated using Equations 17-20 for the critic neural network, and Equation 9 for the actor neural network. The parameters of the actor neural network may be updated by gradient descent in the direction of the natural gradient of w of the critic neural network. Other forms of gradient descent may be used in other embodiments.

At S758, the caching module may cache the plurality of function parameters updated at S756, which may be used to determine and update eligibility traces of each neural network. The values of x^{[t+1]}, α^{[t]}, β^{[t]}, and γ^{[t]} may be updated. In some embodiments, the previous values of x^{[t+1]}, α^{[t]}, β^{[t]}, and γ^{[t]} may be deleted.

When using a stochastic policy task with high-dimensional actions to evaluate the performance of DyNAC as compared to previous state-of-art energy-based actor critic learning using restricted Boltzmann machines (RBMs) the DyNAC learning rule may converge very fast to the maximal average reward with significantly less actions as compared to the RBM energy-based natural actor-critic method EQNAC. While the EQNAC method can only learn a memoryless optimal solution, DyNAC, based on its memory of past actions, may achieve performance close to the optimal average reward per time step.

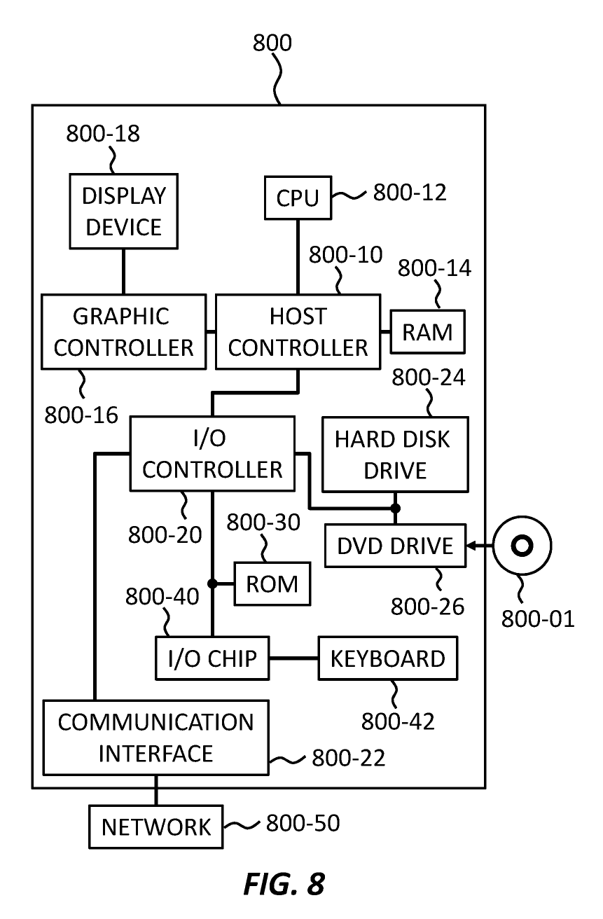

FIG. 8 shows an exemplary hardware configuration of a computer configured to perform the foregoing operations, according to some embodiments. A program that is installed in the computer 800 can cause the computer 800 to function as or perform operations associated with apparatuses of the embodiments of the present disclosure or one or more modules (including modules, components, elements, etc.) thereof, and/or cause the computer 800 to perform processes of the embodiments of the present disclosure or steps thereof. Such a program may be executed by the CPU 800-12 to cause the computer 800 to perform certain operations associated with some or all of the blocks of flowcharts and block diagrams described herein. For example, the cooperative neural network reinforcement learning method of FIG. 5 can be performed by the computer 800.

The computer 800 according to the present embodiment includes a CPU 800-12, a RAM 800-14, a graphics controller 800-16, and a display device 800-18, which are mutually connected by a host controller 800-10. The computer 800 also includes input/output units such as a communication interface 800-22, a hard disk drive 800-24, a DVD-ROM drive 800-26 and an IC card drive, which are connected to the host controller 800-10 via an input/output controller 800-20. The computer also includes legacy input/output units such as a ROM 800-30 and a keyboard 800-42, which are connected to the input/output controller 800-20 through an input/output chip 800-40.

The CPU 800-12 operates according to programs stored in the ROM 800-30 and the RAM 800-14, thereby controlling each unit. The graphics controller 800-16 obtains image data generated by the CPU 800-12 on a frame buffer or the like provided in the RAM 800-14 or in itself, and causes the image data to be displayed on the display device 800-18.

The communication interface 800-22 communicates with other electronic devices via a network 800-50. The hard disk drive 800-24 stores programs and data used by the CPU 800-12 within the computer 800. The DVD-ROM drive 800-26 reads the programs or the data from the DVD-ROM 800-01, and provides the hard disk drive 800-24 with the programs or the data via the RAM 800-14. The IC card drive reads programs and data from an IC card, and/or writes programs and data into the IC card.

The ROM 800-30 stores therein a boot program or the like executed by the computer 800 at the time of activation, and/or a program depending on the hardware of the computer 800. The input/output chip 800-40 may also connect various input/output units via a parallel port, a serial port, a keyboard port, a mouse port, and the like to the input/output controller 800-20.

A program is provided by computer readable media such as the DVD-ROM 800-01 or the IC card. The program is read from the computer readable media, installed into the hard disk drive 800-24, RAM 800-14, or ROM 800-30, which are also examples of computer readable media, and executed by the CPU 800-12. The information processing described in these programs is read into the computer 800, resulting in cooperation between a program and the above-mentioned various types of hardware resources. An apparatus or method may be constituted by realizing the operation or processing of information in accordance with the usage of the computer 800-

For example, when communication is performed between the computer 800 and an external device, the CPU 800-12 may execute a communication program loaded onto the RAM 800-14 to instruct communication processing to the communication interface 800-22, based on the processing described in the communication program. The communication interface 800-22, under control of the CPU 800-12, reads transmission data stored on a transmission buffering region provided in a recording medium such as the RAM 800-14, the hard disk drive 800-24, the DVD-ROM 800-01, or the IC card, and transmits the read transmission data to network 800-50 or writes reception data received from network 800-50 to a reception buffering region or the like provided on the recording medium.

In addition, the CPU 800-12 may cause all or a necessary portion of a file or a database to be read into the RAM 800-14, the file or the database having been stored in an external recording medium such as the hard disk drive 800-24, the DVD-ROM drive 800-26 (DVD-ROM 800-01), the IC card, etc., and perform various types of processing on the data on the RAM 800-14. The CPU 800-12 may then write back the processed data to the external recording medium.

Various types of information, such as various types of programs, data, tables, and databases, may be stored in the recording medium to undergo information processing. The CPU 800-12 may perform various types of processing on the data read from the RAM 800-14, which includes various types of operations, processing of information, condition judging, conditional branch, unconditional branch, search/replace of information, etc., as described throughout this disclosure and designated by an instruction sequence of programs, and writes the result back to the RAM 800-14. In addition, the CPU 800-12 may search for information in a file, a database, etc., in the recording medium. For example, when a plurality of entries, each having an attribute value of a first attribute is associated with an attribute value of a second attribute, are stored in the recording medium, the CPU 800-12 may search for an entry matching the condition whose attribute value of the first attribute is designated, from among the plurality of entries, and reads the attribute value of the second attribute stored in the entry, thereby obtaining the attribute value of the second attribute associated with the first attribute satisfying the predetermined condition.

The above-explained program or software modules may be stored in the computer readable media on or near the computer 800. In addition, a recording medium such as a hard disk or a RAM provided in a server system connected to a dedicated communication network or the Internet can be used as the computer readable media, thereby providing the program to the computer 800 via the network.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes. For example, the neural networks disclosed herein can be deployed in a cloud computing environment.

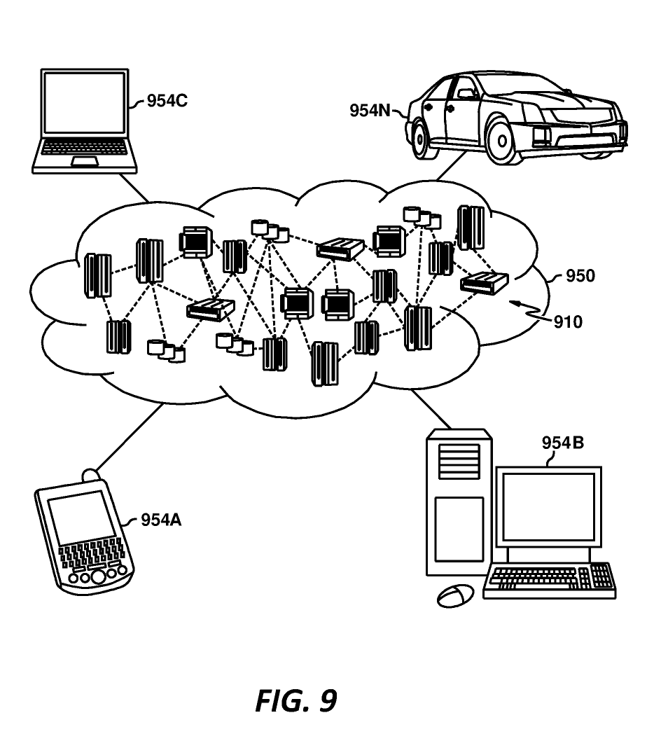

Referring now to FIG. 9, illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 1 are intended to be illustrative only and that computing nodes 910 and cloud computing environment 950 can communicate with any type of computerized device over any type of network and/or network addressable connection (e.g., using a web browser).

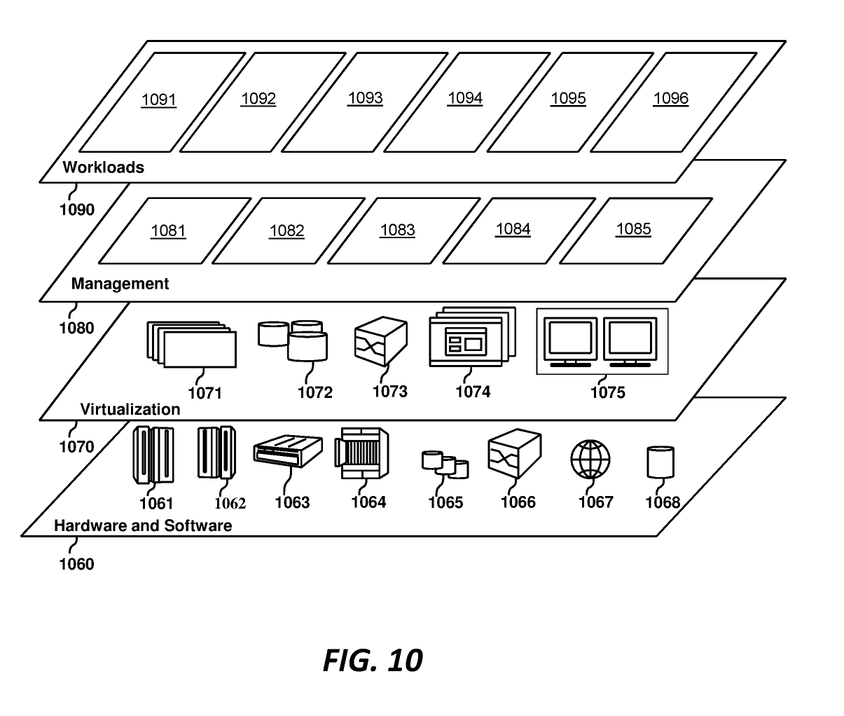

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and selection of action 1096.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A computer program product comprising a computer readable storage medium having program instructions embodied therewith, the program instructions when executed cause a computer to:
obtain an action;
obtain an observation sequence;
input each time frame of the action and observation sequence sequentially into a first neural network including a plurality of first parameters and a second neural network including a plurality of second parameters;
approximate an action-value function using the first neural network;
update the plurality of second parameters to approximate a policy of actions by using updated first parameters.

2. The computer program product according to claim 1, wherein the first neural network further comprises:
a plurality of layers of nodes among a plurality of nodes, each layer sequentially forwarding input values of a time frame of the action and observation sequence to a subsequent layer among the plurality of layers, the plurality of layers of nodes including,
an input layer including the plurality of input nodes among the plurality of nodes, the input nodes receiving input values representing an action and an observation of a current time frame of the action and observation sequence, and
a plurality of intermediate layers, each node in each intermediate layer forwarding a value representing an action or an observation to a node in a subsequent or shared layer, and
a plurality of weight values among the plurality of first parameters of the first neural network, each weight value to be applied to each value in the corresponding node to obtain a value propagating from a pre-synaptic node to a post-synaptic node.

3. The computer program product of claim 1, wherein the action-value function is an energy function of the first neural network.

4. The computer program product of claim 1, wherein the action-value function is a linear function.

5. The computer program product of claim 1, wherein the second neural network further comprises:
a plurality of layers of nodes among a plurality of nodes, each layer sequentially forwarding input values of a time frame of the action and observation sequence to a subsequent layer among the plurality of layers, the plurality of layers of nodes including,
an input layer including the plurality of input nodes among the plurality of nodes, the input nodes receiving input values representing an action and an observation of a current time frame of the action and observation sequence, and
a plurality of intermediate layers, each node in each intermediate layer forwarding a value representing an action or an observation to a node in a subsequent or shared layer, and
a plurality of weight values among the plurality of second parameters of the second neural network, each weight value to be applied to each value in the corresponding node to obtain a value propagating from a pre-synaptic node to a post-synaptic node.

6. The computer program product of claim 1, wherein the updating of the plurality of second parameters is based on the direction of the natural gradient of the plurality of first parameters.

7. The computer program product of claim 1, wherein the obtaining an action and observation sequence further comprises:
selecting an action, using the second neural network, with which to proceed from a current time frame of the action and observation sequence to a subsequent time frame of the action and observation sequence,
causing the selected action to be performed, and
obtaining an observation of the subsequent time frame of the action and observation sequence.

8. The computer program product of claim 7, wherein the observation obtained further comprises an actual reward.

9. The computer program product of claim 7, wherein
the selecting an action includes evaluating each reward probability of a plurality of possible actions according to a probability function based on the action-value function, and
the selected action among the plurality of possible actions yields the largest reward probability from the probability function.

10. The computer program product of claim 1, wherein the approximating the action-value function further comprises:
determining a current action-value from an evaluation of the action-value function in consideration of an actual reward, and
caching a previous action-value determined for a previous time frame from the action-value function.

11. The computer program product of claim 10, wherein the action-value function is evaluated with respect to nodes of the first neural network associated with actions of the action and observation sequence.

12. The computer program product of claim 11, wherein the approximating the action-value function further comprises calculating a temporal difference error based on an average estimate of reward over time, the previous action-value, the current action-value, and the plurality of first parameters.

13. The computer program product of claim 12, wherein the approximating the action-value function further comprises updating the plurality of first parameters based on the temporal difference error and a learning rate.

14. The computer program product of claim 13, wherein the updating the plurality of second parameters further comprises updating a plurality of eligibility traces and a plurality of first-in-first-out (FIFO) queues.

15. The computer program product of claim 1, wherein a dimensionality of the plurality of first parameters is the same as a dimensionality of the plurality of second parameters.

16. The computer program product of claim 15, wherein a structure of the first neural network is the same as a structure of the second neural network.

17. A method of executing cooperative reinforcement learning within an electronic neural network comprising:
obtaining an action and observation sequence;
inputting each time frame of the action and observation sequence sequentially into a first neural network including a plurality of first parameters and a second neural network including a plurality of second parameters;
approximating an action-value function using the first neural network;
updating the plurality of second parameters to approximate a policy of actions by using updated first parameters.

18. The method of claim 17, wherein the obtaining an action and observation sequence further comprises:
selecting an action, using the second neural network, with which to proceed from a current time frame of the action and observation sequence to a subsequent time frame of the action and observation sequence,
causing the selected action to be performed, and
obtaining an observation of the subsequent time frame of the action and observation sequence.

19. The method of claim 18, wherein the observation obtained includes an actual reward;
wherein the selecting an action includes evaluating each reward probability of a plurality of possible actions according to a probability function based on the action-value function, and
the selected action among the plurality of possible actions yields a largest reward probability from the probability function;
wherein the approximating the action-value function includes:
determining a current action-value from an evaluation of the action-value function in consideration of an actual reward, and
caching a previous action-value determined for a previous time frame from the action-value function;
wherein the action-value function is evaluated with respect to nodes of the first neural network associated with actions of the action and observation sequence;
wherein the approximating the action-value function further includes calculating a temporal difference error based on an average estimate of reward over time, the previous action-value, the current action-value, and the plurality of first parameters;
wherein the approximating the action-value function further includes updating the plurality of first parameters based on the temporal difference error and a learning rate.

20. A device comprising:
an obtaining module configured to obtain an action and observation sequence;
an input module configured to input each time frame of the action and observation sequence sequentially into a first neural network including a plurality of first parameters and a second neural network including a plurality of second parameters;
an approximating module configured to approximate an action-value function using the first neural network;
an updating module configured to update the plurality of second parameters to approximate a policy of actions by using updated first parameters.
